(19) United States
(12) Patent Application Publication
(10) Pub. No.: US 2004/0241313 A1
(43) Pub. Date: Dec. 2, 2004

(54) Food composition and food bars

(76) Inventors: Ravi Nana, Munster, IN (US); Gerald R. Schwetlik, Heiligenhafen, IN (US)

Correspondence Address: LAWRENCE A. CHALETSKY, CARGILL INCORPORATED, LAW/24, 15407 MCGINTY ROAD WEST, WAYZATA, MN, 55391, US

(21) Appl. No.: 10/445,519

(22) Filed: May 27, 2003

(51) Int. Cl. A23J 1/00

(52) U.S. Cl. 426/656

(57) ABSTRACT

There is disclosed a proteinaceous food composition, preferably in the shape or form of a bar. The food composition comprises protein, erythritol, maltitol syrup, glycerol, inulin, and maltodextrin. Other ingredients may be incorporated, as desired, such as artificial sweeteners, flavors, vitamins, minerals, and sources of calcium. Also disclosed is a process for preparing the proteinaceous food composition.

### FIELD OF INVENTION

The present invention relates to a food composition that has reduced sugar level. Also, this invention relates to a method for producing the food composition. Preferably the food composition is useful in the production of food bars.

### SUMMARY OF THE INVENTION

The present invention relates to proteinaceous food compositions that contain erythritol as an ingredient. The proteinaceous food compositions comprise protein, erythritol, maltitol syrup, glycerol, inulin, and maltodextrin. The proteinaceous food composition may preferably be provided in the form of a bar. Furthermore, the proteinaceous food composition may be coated or enrobed, or not, as desired. Preferably, the food composition is coated. Also, provided in the invention is a method for preparing the proteinaceous food composition.

### DETAILED DESCRIPTION OF THE INVENTION

The present invention relates to proteinaceous food compositions that contain erythritol as an ingredient. The proteinaceous food compositions comprise protein, erythritol, maltitol syrup, glycerol, inulin, and maltodextrin. The proteinaceous food composition may preferably be provided in the form of a bar. Furthermore, the proteinaceous food composition may be coated, or enrobed, or not, as desired. Preferably, the food composition is coated. Also provided in the invention is a method for preparing the proteinaceous food composition.

In more detail, the proteinaceous food compositions of the present invention are comprised of about ten (10) to about twenty (20) weight percent protein, about eight (8) to about seventeen (17) weight percent erythritol, about ten (10) to about nineteen (19) weight percent maltitol syrup, about five (5) to about fifteen (15) weight percent glycerol, about four (4) to about six (6) weight percent inulin, and about six (6) to about twelve (12) weight percent maltodextrin. If utilized, the coating comprises from about ten (10) to about forty (40) weight percent.

The protein source utilized in the present proteinaceous food compositions may be any suitable protein source. Exemplary of suitable protein sources are casein hydrolysate, soy protein, preferably in the form of soy protein nuggets, non-fat milk solids, evaporated milk, cream cheese powder, mixtures thereof, and the like.

The erythritol used herein is a four-carbon atom sugar alcohol. The erythritol is a low-caloric bulk sweetener that has a high level of digestive tolerance. Preferably, the erythritol is utilized in a finely milled form having a size of less than about 200 μm (micrometers).

Maltitol syrup utilized in the present proteinaceous food compositions may be any suitable maltitol syrup. Preferably, the maltitol content in the maltitol syrup may range from about fifty (50) weight percent to about eighty-seven (87) weight percent, on dry basis, with dry substance from about seventy (70) to about eighty-five (85) weight percent.

Inulin occurs naturally in many plants and vegetables, such as onions, asparagus, Jerusalem artichoke and chicory. Inulin is a mixture of oligosaccharides and polysaccharides.

Maltodextrin suitable for use in the present proteinaceous food compositions may be obtained by enzymatic conversion of waxy maize starch, cornstarch or, preferably, potato starch.

Optionally, at least one or more other conventional ingredients may be utilized in producing the present proteinaceous food compositions. Included within such suitable conventional ingredients are artificial sweeteners such as sucralose, any natural and/or artificial flavors, any vitamins and/or minerals, sources of calcium, and the like. Typical examples of flavors may include cheese cake flavor, cream cheese flavor, vanillin, freeze dried strawberries, lemon juice, strawberry flavor, and the like. A suitable calcium source is dicalcium phosphate. Mixtures of the ingredients may be used.

Optionally, and preferably, the present proteinaceous food compositions are enrobed or coated. The food composition, where coated, generally comprises an amount of from about ten (10) to about forty (40) weight percent of the coating. Preferably the food composition is enrobed with a coating such that the ratio of food composition to coating is about eighty (80) to about twenty (20). Any ingredient may be utilized as a coating. For example, several typical coatings comprise yoghurt, sugar-free yoghurt, dark and milk chocolate, mixtures thereof, and the like.

The method for preparing the present proteinaceous food composition, preferably in the shape or form of a bar, is comprised as follows:

(a) All dry ingredients of the proteinaceous food composition, except for soy protein nuggets, freeze dried fruits when utilized, and less than half the amount of the casein hydrolysate to be utilized are blended in a Hobart Model—50 mixer, available from Hobart Canada, North York, Ontario. The blending is carried out at speed No. 1, using a regular paddle attachment (N5B ASTM NSF);

(b) The balance of the casein hydrolysate is hydrated with warm maltitol syrup and glycerol in a Hobart mixing bowl for at least ten (10) minutes, to provide a protein mix that is beat at speed #3 for at least five (5) minutes with a wire whisk attachment (N5D NSF);

(c) Separately and preferably simultaneously, freeze dried fruit pieces, such as freeze dried strawberries, where used, are hydrated in evaporated milk for at least ten minutes in a separate bowl;

(d) The dry ingredient blend of (a), the protein mix of (b), the hydrated fruit of (c), if used, and flavors, if used, are mixed in the Hobart mixer using a paddle attachment (N5B) for about two to three minutes to provide a second dry ingredient blend. Following the mixing, soy protein, preferably in the form of nuggets, is added to the second dry ingredient blend, and the mixture is mixed for an additional approximately two minutes, such that a consistency of dough is achieved;

(e) Optionally, and preferably, the dry ingredient mix of (d) is extruded or sheeted to a thickness of about one-half inch to about three-fourths inch, and then cut into bars of any desired size; and

(f) Optionally, and preferably, the bars of (e) are enrobed or coated in any known manner with any suitable coating, such as a sugar free yoghurt coating, or a dark or milk chocolate flavored coating.

It has been found that the present proteinaceous food compositions and bars produced there from may be natural products, may be non-caloric (having a value of less than 0.2 kcal/g), may be suitable for diabetics, and may exhibit high digestive tolerance.

The invention will be more readily understood by reference to the following examples. There are, of course, many other forms of the invention which will become obvious to one skilled in the art, once the invention has been fully disclosed, and it will accordingly be recognized that these examples are given for the purpose of illustration only, and are not to be construed as limiting the scope of this invention in any way.

### EXAMPLE 1

In this example there was produced a reduced-sugar proteinaceous food composition, in the form of a bar. The ingredients utilized in producing the food bars are comprised as follows:

| Ingredients | Weight % |
|---|---|
| Casein hydrolysate | 10.66 |
| Erythritol <200 μm | 13.31 |
| Maltitol syrup | 15.10 |
| Maltodextrin | 7.10 |
| Inulin | 4.44 |
| Evaporated milk | 9.32 |
| Cream cheese powder | 7.10 |
| Glycerol | 8.87 |
| Cheese Buds - Cream cheese | 1.33 |
| Cheese cake flavour | 0.44 |
| Cream cheese flavour | 0.44 |
| Vanillin | 0.18 |
| Non fat milk solids | 9.75 |
| Freeze dried strawberries | 2.66 |
| Lemon Juice | 0.32 |
| Strawberry flavour | 0.13 |
| 50% soy protein nuggets | 6.66 |
| Sucralose powder | 0.02 |
| Dicalcium phosphate | 1.50 |
| Premix vitamins | 0.67 |

The coating that enrobes the food composition is comprised of sugar free yoghurt, and is applied such that the ratio of food composition to coating is about 80:20.

The reduced-sugar proteinaceous food composition bar was prepared as follows:

1. Prehydrate 4 parts of the casein hydrolysate in slightly warm maltitol syrup and glycerol in a Hobart mixing bowl. Hydrate the freeze-dried strawberries in evaporated milk. Let both stand for a minimum of ten (10) minutes.

2. Beat the above protein mix at speed #3 for five (5) minutes with a wire whisk.

3. Blend all dry ingredients including the remaining casein hydrolysate in a separate mixing bowl.

4. Change the blade on the Hobart mixer to the paddle attachment. Add the above dry blend, strawberry mix, lemon juice and strawberry flavour and mix for two to three minutes. Add soy protein nuggets and mix for a further two minutes, or until dough consistency is obtained.

5. Extrude or sheet the dough and cut into the desired size bar.

6. The bars are enrobed or coated with a sugar-free yoghurt coating in an amount such that the ratio of food bar to coating is about 80:20.

It should be clearly understood that the forms of the invention herein described are illustrative only and are not intended to limit the scope of the invention. The present invention includes all modifications falling within the scope of the following claims.

We claim:

1. A proteinaceous food composition comprising, on a weight basis:
(a) from about 10% to about 20% protein,
(b) from about 8% to about 17% erythritol,
(c) from about 10% to about 19% maltitol syrup,
(d) from about 5% to about 15% glycerol,
(e) from about 4% to about 6% inulin, and
(f) from about 6% to about 12% maltodextrin.

2. The proteinaceous food composition according to claim 1 wherein the food composition is enrobed with a coating.

3. The proteinaceous food composition according to claim 2 wherein the coating is present in an amount of from about 10 weight percent to about 40 weight percent.

4. The proteinaceous food composition according to claim 2 wherein the coating is present in an amount such that the ratio of food composition to coating ranges from about 80:20.

5. The proteinaceous food composition according to claim 1 wherein the protein is selected from the group consisting of casein hydrolysate, soy protein, non-fat milk solids, evaporated milk, cream cheese powder, and mixtures thereof.

6. The proteinaceous food composition according to claim 1 wherein the erythritol has a size of less than 200 μm (micrometers).

7. The proteinaceous food composition according to claim 1 wherein the maltitol syrup has a maltitol content ranging from about 50 weight percent to about 87 weight percent, on dry basis.

8. The proteinaceous food composition according to claim 2 wherein the coating is selected from the group consisting of yoghurt, sugar-free yoghurt, dark chocolate, milk chocolate, and mixtures thereof.

9. The proteinaceous food composition according to claim 1 in the form of a bar.

10. The proteinaceous food composition according to claim 1 further comprising at least one ingredient selected from the group consisting of an artificial sweetener, a flavor, a vitamin, a mineral, a calcium source, and mixtures thereof.

11. A proteinaceous food composition comprised as follows:

| Ingredients | Weight % |
|---|---|
| Casein hydrolysate | 10.66 |
| Erythritol <200 μm | 13.31 |
| Maltitol syrup | 15.10 |
| Maltodextrin | 7.10 |
| Inulin | 4.44 |
| Evaporated milk | 9.32 |
| Cream cheese powder | 7.10 |
| Glycerol | 8.87 |
| Cheese Buds - Cream cheese | 1.33 |
| Cheese cake flavour | 0.44 |
| Cream cheese flavour | 0.44 |
| Vanillin | 0.18 |
| Non fat milk solids | 9.75 |
| Freeze dried strawberries | 2.66 |
| Lemon juice | 0.32 |
| Strawberry flavour | 0.13 |
| 50% soy protein nuggets | 6.66 |
| Sucralose powder | 0.02 |
| Dicalcium phosphate | 1.50 |
| Premix vitamins | 0.67 |

12. The proteinaceous food composition according to claim 11 further comprising a coating thereon comprising sugar-free yoghurt, present in an amount such that the ratio of proteinaceous food composition to coating is about 80:20.

13. A process for preparing a proteinaceous food composition comprising:
(a) blending all dry ingredients, except for soy protein, and less than half the amount of casein hydrolysate, to provide a first dry ingredient blend;
(b) hydrating the remaining amount of casein hydrolysate with warm maltitol syrup and glycerol for at least ten minutes to provide a protein mix;
(c) beating the protein mix of (b) for at least five minutes;
(d) mixing the first dry ingredient blend of (a) with the protein mix of (c), and mixing for about two to about three minutes, to provide a second dry ingredient blend; and
(e) adding soy protein to the second dry ingredient blend to provide a mixture, and mixing the mixture for about two minutes such that a consistency of dough is achieved.

14. The process according to claim 13 wherein freeze dried fruit pieces that have been hydrated in evaporated milk, are introduced into step (d).

15. The process according to claim 13, further comprising extruding or sheeting the mixture of (e) to form a sheet, and forming the sheet into bar.

16. The process according to claim 13 wherein the resultant proteinaceous food composition is enrobed with a coating.

17. The process according to claim 15 wherein the resultant bar is enrobed with a coating.

18. The process according to claim 17 wherein the coating is selected from the group consisting of yoghurt, sugar-free yoghurt, dark chocolate, milk chocolate, and mixtures thereof.

19. The process according to claim 17 wherein the coating is present in an amount of from about ten weight percent to about forty weight percent.

20. The process according to claim 13 further comprising incorporating at least one or more ingredient selected from the group consisting of an artificial sweetener, a flavor, a vitamin, a mineral, a calcium source, and mixtures thereof.
